(19) United States
(12) Patent Application Publication
(10) Pub. No.: US 2013/0050071 A1
(43) Pub. Date: Feb. 28, 2013

(54) THREE-DIMENSIONAL IMAGE PROCESSING APPARATUS AND THREE-DIMENSIONAL IMAGE PROCESSING METHOD

(71) Applicants: Tomohiro Matano, Tokyo (JP); Motoyuki Hirakata, Tokyo (JP)

(72) Inventors: Tomohiro Matano, Tokyo (JP); Motoyuki Hirakata, Tokyo (JP)

(73) Assignee: KABUSHIKI KAISHA TOSHIBA, Tokyo (JP)

(21) Appl. No.: 13/410,010

(22) Filed: Mar. 1, 2012

(30) Foreign Application Priority Data
Aug. 30, 2011 (JP) 2011-186944

(51) Int. Cl. G06F 3/01

(52) U.S. Cl. 345/156

(57) ABSTRACT

In one embodiment, a three-dimensional image processing apparatus includes: an imaging module configured to image a field including a front of a display, the display displays a three dimensional image; and a controller configured to control the display to display an image imaged by the imaging module and a field where the three-dimensional image is recognizable as a three-dimensional body.

### CROSS-REFERENCE TO RELATED APPLICATION

This application is based upon and claims the benefit of priority from Japanese Patent Application No. 2011-186944, filed on Aug. 30, 2011; the entire contents of which are incorporated herein by reference.

### FIELD

Embodiments relate generally to a three-dimensional image processing apparatus and a three-dimensional image processing method.

### BACKGROUND

In recent years, image processors including a display through which a three-dimensional image can be viewed (hereinafter, described as three-dimensional image processors) have been developed and released. Systems of the three-dimensional image processors include the one in which a pair of glasses are required for viewing the three-dimensional image (hereinafter, described as a glasses-system) and the one in which the three-dimensional image can be viewed with naked eyes without requiring a pair of glasses (hereinafter, a glasses-free system).

Examples of the glasses-system include an anaglyph system in which color filters are used for the glasses to divide the images for the left eye and the right eye, a polarizing filter system in which polarizing filters are used to divide the images for the left eye and the right eye, and a time division system in which shutters are used to divide the images for the left eye and the right eye. Examples of the glasses-free system include an integral imaging system in which orbits of light beams from pixels constituting a synthesized image in which pixels of a plurality of images having parallax are discretely arranged in one image are controlled using a lenticular lens or the like to cause an observer to perceive a three-dimensional image, and a parallax barrier system in which slits are formed in one plate to limit the vision of the image.

In the three-dimensional processor, a field where the image can be recognized as a three-dimensional body (a three-dimensional object) (hereinafter, described as a visual field) is determined. Therefore, a user cannot recognize the image as a three-dimensional body outside the visual field. Hence, a three-dimensional image processor is proposed in which a camera is installed so that the position of the user is specified from the image imaged by the camera, and the specified position of the user is displayed on a screen together with the visual field.

### BRIEF DESCRIPTION OF THE DRAWINGS

FIG. 1 is a schematic view of a three-dimensional image processor according to an embodiment.

FIG. 2 is a configuration diagram of the three-dimensional image processor according to the embodiment.

FIG. 3 is a view illustrating a field (visual field) where an image is recognizable as a three-dimensional body.

FIG. 4 is a flowchart illustrating the operation of the three-dimensional image processor according to the embodiment.

FIG. 5 is an explanatory view of an optimal viewing position.

FIGS. 6A and 6B are examples of calibration images displayed on a display screen.

### DETAILED DESCRIPTION

A three-dimensional image processing apparatus according to an embodiment includes an imaging module imaging a field including a front of a e display, the display displays a three dimensional image, and a controller controlling the display to display an image imaged by the imaging module and a field where the three-dimensional image is recognizable as a three-dimensional body.

Hereinafter, an embodiment will be described referring to the drawings.

### Embodiment

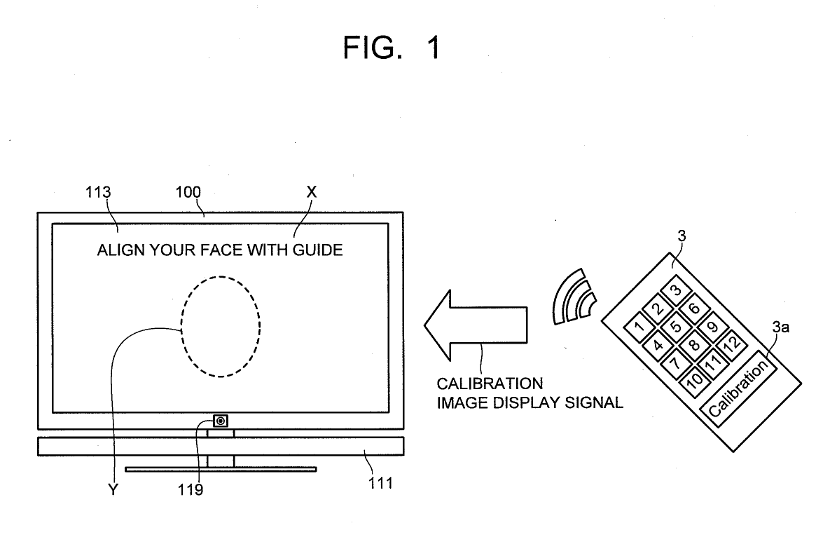

FIG. 1 is a schematic view of a three-dimensional image processor (a three-dimensional image processing apparatus) 100 according to an embodiment. At the beginning, the outline of the three-dimensional image processor 100 according to the embodiment will be described referring to FIG. 1. The three-dimensional image processor 100 is, for example, a digital television. The three-dimensional image processor 100 presents a three-dimensional image to a user by the integral imaging system in which pixels of a plurality of images having parallax (multi-view images) are discretely arranged in one image (hereinafter, described as a synthesized image), and the orbits of light beams from the pixels constituting the synthesized image are controlled using a lenticular lens to cause an observer to perceive a three-dimensional image.

For the three-dimensional image, the visual field is limited as has been described. When the user is located outside the visual field, the user cannot recognize the image as a three-dimensional body due to occurrence of so-called reverse view, crosstalk, or the like. Hence, the three-dimensional image processor 100 is configured such that when the user depresses an operation key (calibration key) 3a on a remote controller 3, a frame shaped guide Y indicating the field (visual field) where the three-dimensional image is recognizable as a three-dimensional body is superposed on the image imaged by a camera module 119 provided at the front surface of the three-dimensional image processor 100 and displayed on a display 113. In addition, an instruction X to the user that “Align your face with guide” is displayed on the display 113.

Following the instruction X, the user aligns his or her face displayed on the display 113 with the inside of the guide Y and thereby can easily view the three-dimensional image at an appropriate position. In the following description, the image made by superposing the guide Y indicating the field (visual field) where the three-dimensional image is recognizable as a three-dimensional body on the image imaged by the camera module 119 provided at the front surface of the three-dimensional image processor 100 is called a calibration image.

### (Configuration of the Three-Dimensional Image Processor 100)

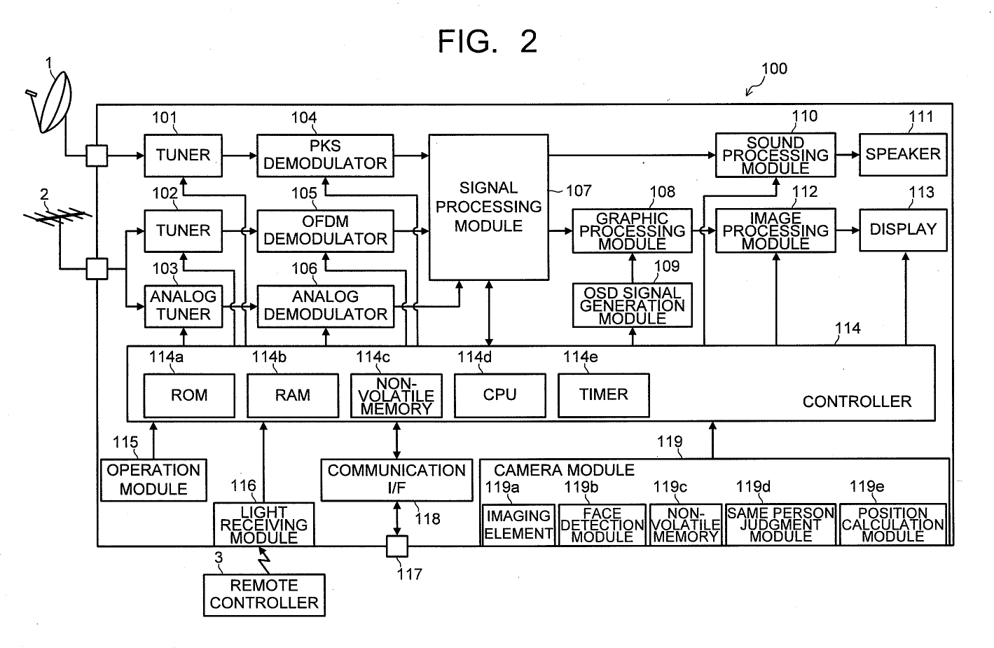

FIG. 2 is a configuration diagram of the three-dimensional image processor 100 according to the embodiment. The three-dimensional image processor 100 includes a tuner 101, a tuner 102, a tuner 103, a PSK (Phase Shift Keying) demodulator 104, an OFDM (Orthogonal Frequency Division Multiplexing) demodulator 105, an analog demodulator 106, a signal processing module 107, a graphic processing module 108, an OSD (On Screen Display) signal generation module 109, a sound processing module 110, a speaker 111, an image processing module 112, the display 113, the controller 114, an operation module 115, a light receiving module 116 (operation accepting module), a terminal 117, a communication I/F (Inter Face) 118, and the camera module 119.

The tuner 101 selects a broadcast signal of a desired channel from satellite digital television broadcasting received by an antenna 1 for receiving BS/CS digital broadcasting, based on the control signal from the controller 114. The tuner 101 outputs the selected broadcast signal to the PSK demodulator 104. The PSK demodulator 104 demodulates the broadcast signal inputted from the tuner 101 and outputs the demodulated broadcast signal to the signal processing module 107, based on the control signal from the controller 114.

The tuner 102 selects a digital broadcast signal of a desired channel from terrestrial digital television broadcast signal received by an antenna 2 for receiving terrestrial broadcasting, based on the control signal from the controller 114. The tuner 102 outputs the selected digital broadcast signal to the OFDM demodulator 105. The OFDM demodulator 105 demodulates the digital broadcast signal inputted from the tuner 102 and outputs the demodulated digital broadcast signal to the signal processing module 107, based on the control signal from the controller 114.

The tuner 103 selects an analog broadcast signal of a desired channel from terrestrial analog television broadcast signal received by the antenna 2 for receiving terrestrial broadcasting, based on the control signal from the controller 114. The tuner 103 outputs the selected analog broadcast signal to the analog demodulator 106. The analog demodulator 106 demodulates the analog broadcast signal inputted from the tuner 103 and outputs the demodulated analog broadcast signal to the signal processing module 107, based on the control signal from the controller 114.

The signal processing module 107 generates an image signal and a sound signal from the demodulated broadcast signals inputted from the PSK demodulator 104, the OFDM demodulator 105, and the analog demodulator 106. The signal processing module 107 outputs the image signal to the graphic processing module 108. The signal processing module 107 further outputs the sound signal to the sound processing module 110.

The OSD signal generation module 109 generates an OSD signal and outputs the OSD signal to the graphic processing module 108 based on the control signal from the controller 114.

The graphic processing module 108 generates a plurality of pieces of image data (multi-view image data) from the image signal outputted from the signal processing module 107 based on the instruction from the controller 114. The graphic processing module 108 discretely arranges pixels of the generated multi-view images in one image to thereby convert them into a synthesized image. The graphic processing module 108 further outputs the OSD signal generated by the OSD signal generation module 109 to the image processing module 112.

The image processing module 112 converts the synthesized image converted by the graphic processing module 108 into a format which can be displayed on the display 113 and then outputs the converted synthesized image to the display 113 to cause it to display a three-dimensional image. The image processing module 112 converts the inputted OSD signal into a format which can be displayed on the display 113 and then outputs the converted OSD signal to the display 113 to cause it to display an image corresponding to the OSD signal.

The display 113 is a display for displaying a three-dimensional image of the integral imaging system including a lenticular lens for controlling the orbits of the light beams from the pixels.

The sound processing module 110 converts the inputted sound signal into a format which can be reproduced by the speaker 111 and then outputs the converted sound signal to the speaker 111 to cause it to reproduce sound.

On the operation module 115, a plurality of operation keys (for example, a cursor key, a decision (OK) key, a BACK (return) key, color keys (red, green, yellow, blue) and so on) for operating the three-dimensional image processor 100 are arranged. The user depresses the above-described operation key, whereby the operation signal corresponding to the depressed operation key is outputted to the controller 114.

The light receiving module 116 receives an infrared signal transmitted from the remote controller 3. On the remote controller 3, a plurality of operation keys (for example, a calibration key, an end key, a cursor key, a decision key, a BACK (return) key, color keys (red, green, yellow, blue) and so on) for operating the three-dimensional image processor 100 are arranged.

The user depresses the above-described operation key, whereby the infrared signal corresponding to the depressed operation key is emitted. The light receiving module 116 receives the infrared signal emitted from the remote controller 3. The light receiving module 116 outputs an operation signal corresponding to the received infrared signal to the controller 114.

The user can operate the operation module 115 or the remote controller 3 to cause the three-dimensional image processor 100 to perform various operations. For example, the user can depress the calibration key on the remote controller 3 to display the calibration image described referring to FIG. 1 on the display 113.

The terminal 117 is a USB terminal, a LAN terminal, an HDMI terminal, or an iLINK terminal for connecting an external terminal (for example, a USB memory, a DVD storage and reproduction device, an Internet server, a PC or the like).

The communication I/F 118 is a communication interface with the above-described external terminal connected to the terminal 117. The communication I/F 118 converts the control signal and the format of data and so on between the controller 114 and the above-described external terminal.

The camera module 119 is provided on the lower front side or the upper front side of the three-dimensional image processor 100. The camera module 119 includes an imaging element 119a, a face detection module 119b, a non-volatile memory 119c, a same person judgment module 119d, and a position calculation module 119e.

The imaging element 119a images a field including the front of the three-dimensional image processor 100. The imaging element 119a is, for example, a CMOS image sensor or a CCD image sensor.

The face detection module 119b detects the face of a user from the image imaged by the imaging element 119a. The face detection module 119b divides the imaged image into a plurality of areas. The face detection module 119b performs face detection for all of the divided areas.

For the face detection by the face detection module 119b, a known method can be used. For example, a method of directly geometrically comparing visual features to a face detection algorithm can be used. The face detection module 119b stores information on feature points of the detected face into the non-volatile memory 119c.

In the non-volatile memory 119c, the information on the feature points of the face detected by the face detection module 119b are stored.

The same person judgment module 119d judges whether the feature points of the face detected by the face detection module 119b have been already stored in the non-volatile memory 119c. When the feature points have been already stored in the non-volatile memory 119c, the same person judgment module 119d judges that a same person is detected. On the other hand, when the feature points have not been stored in the non-volatile memory 119c, the same person judgment module 119d judges that the person whose face has been detected is not a same person. The judgment can prevent the guide Y from being displayed again for the user who has been already detected by the face detection module 119b.

When the same person judgment module 119d judges that the person whose face has been detected is not a same person, the position calculation module 119e calculates position coordinates (X, Y, Z) in an actual space from a position (α, β) on the image of the user whose face has been detected by the face detection module 119b and a distance γ between the imaging element 119a and the user. For the calculation of the position coordinates in the actual space, a known method can be used. Note that the upper left corner of the image imaged by the camera 110a is regarded as an origin (0, 0), and an α-axis is set in the horizontal direction and a β-axis is set in the longitudinal direction. For the coordinates in the actual space, the center of the display surface of the display 113 is regarded as an origin (0, 0, 0), and an X-axis is set in the horizontal lateral direction, a Y-axis is set in the vertical direction, and a Z-axis is set in the direction normal to the display surface of the display 113.

From the imaged image, the position (α, β) in the top-bottom direction and the right-left direction of the user is found. Further, from the distance between the right eye and the left eye of the face, the distance from the imaging element 119a to the user can be calculated. Normally, the distance between the right eye and the left eye of a human being is about 65 mm, so that if the distance between the right eye and the left eye in the imaged image is found, the distance γ from the imaging element 119a to the user can be calculated.

If the above-described position (α, β) of the user on the image and the distance γ from the imaging element 119a to the user are found, the position coordinates (X, Y, Z) of the user in the actual space can be calculated. The position coordinates (X, Y, Z) of the user in the actual space can be calculated, for example, by obtaining the distance in the actual space in advance from the distance in the actual space per pixel of the imaging element 119a, and multiplying the number of pixels from the origin to the user on the image by the distance in the actual space per pixel.

The controller 114 includes a ROM (Read Only Memory) 114a, a RAM (Random Access Memory) 114b, a non-volatile memory 114c, and a CPU 114d. In the ROM 114a, a control program executed by the CPU 114d is stored. The RAM 114b serves as a work area for the CPU 114d. In the non-volatile memory 114c, various kinds of setting information, visual field information and so on are stored. The visual field information is the coordinate (X, Y, Z) data of the visual field in the actual space.

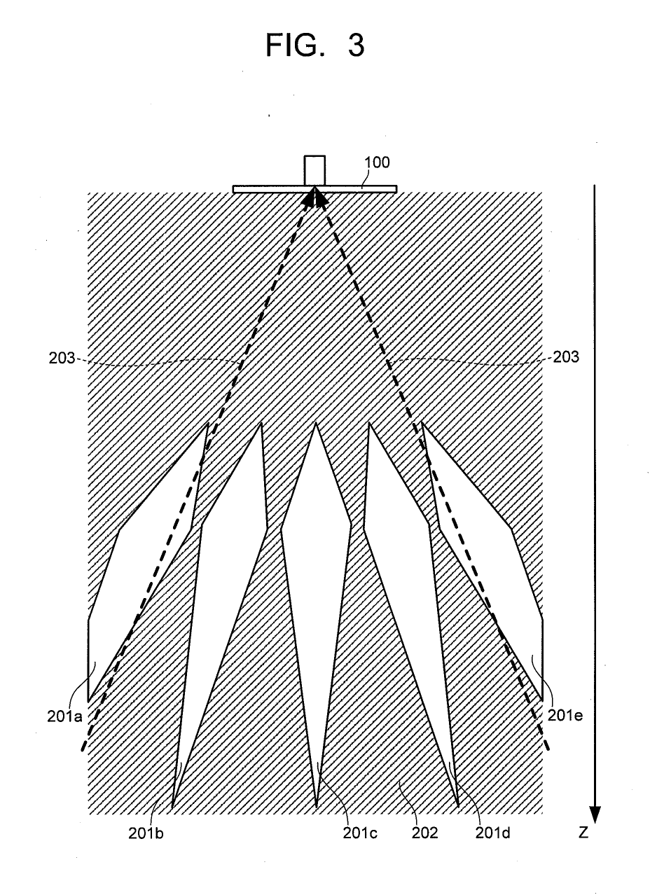

FIG. 3 is a bird's-eye view of the coordinate (X, Y, Z) data of the visual field in the actual space stored in the non-volatile memory 114c. In FIG. 3, white quadrilateral ranges 201a to 201e indicate fields where the image (three-dimensional image) displayed on the display 113 is recognizable as a three-dimensional body, that is, the visual fields (hereinafter, the quadrilateral ranges 201a to 201e are described as the visual fields 201a to 201e). On the other hand, a diagonal-line field 202 is a field where the user cannot recognize the image as a three-dimensional body due to occurrence of so-called reverse view, crosstalk, or the like, that is, outside the visual field.

Broken lines 203 in FIG. 3 indicate the boundaries of the imaging range of the imaging element 119a. In other words, the range actually imaged by the imaging element 119a is a range on the lower side of the broken lines 203. Therefore, storage into the non-volatile memory 114c of an upper left range and an upper right range of the broken lines 203 may be omitted.

The controller 114 controls the whole three-dimensional image processor 100. Concretely, the controller 114 controls the operation of the whole three-dimensional image processor 100 based on the operation signals inputted from the operation module 115 and the light receiving module 116 and the setting information stored in the non-volatile memory 114c. For example, when the user depresses the calibration key 3a on the remote controller 3, the controller 114 displays the above-descried calibration image on the display 113.

### (Operation of the Three-Dimensional Image Processor 100)

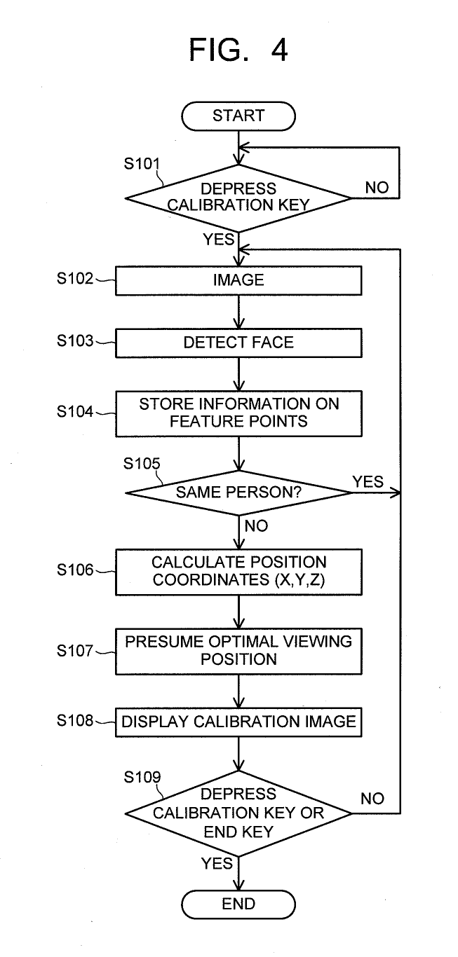

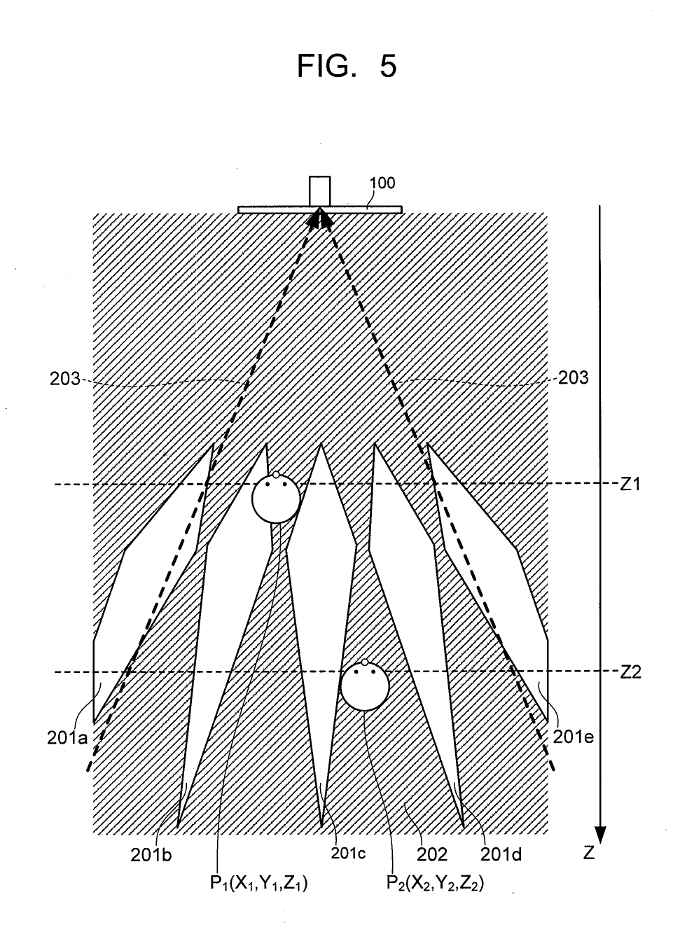

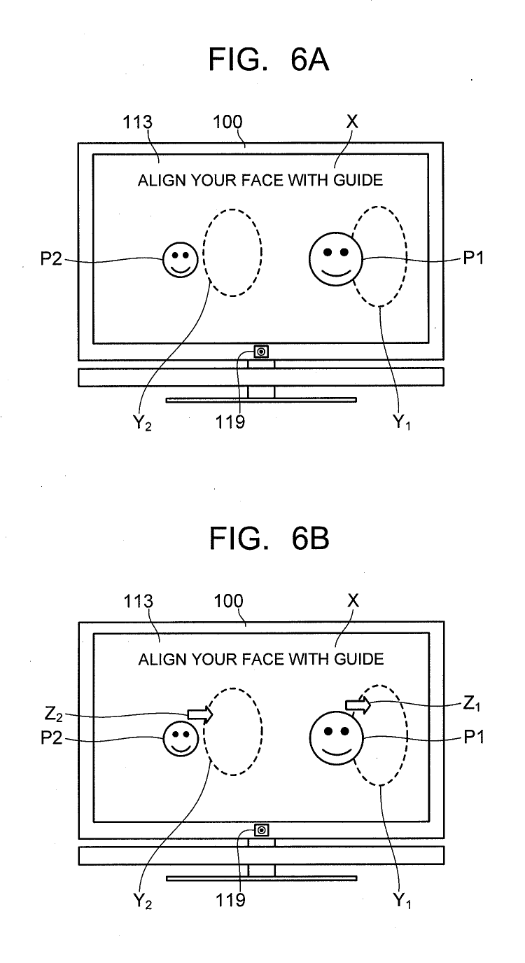

FIG. 4 is a flowchart illustrating the operation of the three-dimensional image processor 100. FIG. 5 is an explanatory view of an optimal viewing position. FIGS. 6A and 6B are calibration images displayed on the display 113. Hereinafter, the operation of the three-dimensional image processor 100 will be described referring to FIG. 4 to FIGS. 6A and 6B.

When the user depresses the calibration key 3a on the remote controller 3, the infrared signal corresponding to the depressed calibration key 3a is emitted (Step S101). The light receiving module 116 receives the infrared signal emitted from the remote controller 3. The light receiving module 116 outputs an operation signal (calibration image display signal) corresponding to the received infrared signal to the controller 114.

Upon receipt of the calibration image display signal, the controller 114 instructs the camera module 119 to start imaging. The camera module 119 images the front of the three-dimensional image processor 100 by the imaging element 119a based on the instruction from the controller 114 (Step S102).

The face detection module 119b performs detection of the face from the image imaged by the imaging element 119a (Step S103). The face detection module 119b divides the imaged image into a plurality of areas and performs face detection for all of the divided areas. The face detection module 119b stores information on the feature points of the detected face into the non-volatile memory 119c (Step S104). Note that the face detection module 119b performs face detection periodically (for example, every several seconds to several tens of seconds) for the image imaged by the imaging element 119a.

The same person judgment module 119d judges whether the feature points of the face detected by the face detection module 119b have been already stored in the non-volatile memory 119c (Step S105). When the feature points have been already stored in the non-volatile memory 119c (Yes at Step S105), the camera module 119 returns to the operation at Step S102.

When the feature points have not been stored yet in the non-volatile memory 119c (No at Step S105), the position calculation module 119e calculates the position coordinates (X, Y, Z) in the actual space of the face detected by the face detection module 119b (Step S106). When faces of a plurality of persons are detected by the face detection module 119b, the position calculation module 119e calculates the position coordinates (X, Y, Z) in the actual space of each of the faces. The position calculation module 119e outputs the calculated position coordinates (X, Y, Z) in the actual space to the controller 114.

When the position coordinates (X, Y, Z) are outputted from the position calculation module 119e, the controller 114 refers to the visual field information stored in the non-volatile memory 114c and presumes a visual field that is closest from the position coordinates (Step S107).

The above-described operation will be described referring to in FIG. 5. In the example illustrated in FIG. 5, it is assumed that two users P₁, P₂ have been detected in an image imaged by the imaging element 119a. The controller 114 presumes that the visual fields 201b, 201c are closest to the position coordinates (X₁, Y₁, Z₁), (X₂, Y₂, Z₂) of the two users P₁, P₂ among the visual fields 201a to 201e.

The controller 114 obtains the ranges of the visual fields at the positions of the Z coordinate Z₁, Z₂ of the two users P₁, P₂. The controller 114 then calculates the ranges on the image imaged by the imaging element 119a from the ranges of the visual fields at the positions of the obtained Z coordinates Z₁, Z₂. For the calculation of the ranges on the image, a known method can be used. For example, the ranges may be calculated in the procedure opposite of that when calculating the position coordinates in the actual space of the users from the positions of the users on the image.

The controller 114 instructs the OSD signal generation module 109 to generate an image signal for displaying, on the display 113, the calibration image made by superposing the guides indicating the calculated visual field ranges on the image imaged by the imaging element 119a. The OSD signal generation module 109 generates an image signal of the calibration image based on the instruction from the controller 114. The generated image signal of the calibration image is outputted to the image processing module 112 through the graphic processing module 108.

The image processing module 112 converts the image signal of the calibration image into a format which can be displayed on the display 113 and then outputs it to the display 113. The calibration image is displayed on the display 113 (Step S108).

FIG. 6A is the calibration image displayed on the display 113. In FIG. 6A, a guide Y₁ is a guide for the user Y₁ in FIG. 5. A guide Y₂ is a guide for the user Y₂ in FIG. 5. The users P₁, P₂ follow an instruction X displayed on the display 113 and align their faces with the insides of the guides Y₁, Y₂ respectively. By aligning their faces with the insides of the guides Y₁, Y₂, the users P₁, P₂ can view the three-dimensional image at appropriate positions, that is, inside the visual fields where reverse view, crosstalk, or the like does not occur. Note that the guides Y₁, Y₂ are displayed at substantially the same heights as those of the detected faces of the users P₁, P₂. The visual fields rarely change in the vertical direction (in the X coordinate direction). Therefore, there is no problem to view the three-dimensional image if the guides Y₁, Y₂ are displayed at substantially the same heights as those of the detected faces of the users P₁, P₂.

In the calibration image illustrated in FIG. 6A, there is possibly a case that the users P₁, P₂ hardly know which guides Y₁, Y₂ they should align their faces with respectively. In this case, as illustrated in FIG. 6B, arrows Z₁, Z₂ may be additionally displayed in order for the users P₁, P₂ to know which guides Y₁, Y₂ they should align their faces with respectively. When a plurality of users have been detected, the shapes and colors of the guides Y₁, Y₂ may be changed (for example, the guide Y₁ is indicated by a rectangle, and the guide Y₂ is indicated by an oval). The guide (frame) Y may be indicated by a solid line. Further, though the guides Y₁, Y₂ are indicated by frames, they are not limited to the frames but may be presented by another display method as long as the users can recognize them.

After the calibration image illustrated in FIGS. 6A, 6B is displayed, the controller 114 judges whether the calibration key 3a or the end key on the remote controller 3 is depressed by the user (Step S109). This judgment can be made by whether the operation signal corresponding to the depression of the calibration key 3a or the end key on the remote controller 3 has been received at the controller 114.

When the calibration key 3a or the end key has been depressed (Yes at Step S109), the controller 114 instructs the OSD signal generation module 109 to end the display of the calibration image, with which the operation ends.

As described above, the three-dimensional image processor 100 according to the embodiment includes the imaging element 119a which images the field including the front of the three-dimensional image processor 100. And the three-dimensional image processor 100 detects a user from the image imaged by the camera and display, on the display 113, the calibration image made by superposing the guide indicating the visual field closest to the position of the detected user on the image imaged by the imaging element 119a.

The user can view the three-dimensional image at an appropriate position, that is, inside the visual field where reverse view, crosstalk, or the like does not occur, only by aligning his or her face with the inside of the guide displayed on the display 113. Further, the calibration image is displayed on the display 113 only by depressing the calibration key 3a on the remoter controller 3, which is convenient for the user.

Further, since the visual field which is closest from the position of the user is presented, the user can move to the appropriate position for viewing the three-dimensional image by a small movement amount, leading to an improved convenience for the user. Further, even if there are plurality of users, guides are displayed for the respective users. In addition, when guides (arrows) are displayed for the users to know which guides they should align their faces with respectively, the users can easily understand which guides they should align their faces with respectively, leading to further improved convenience for the users.

Furthermore, the same person judgment module 119d is provided to judge whether the feature points of the face detected by the face detection module 119b have been already stored in the non-volatile memory 119c. When the feature points have been already stored in the non-volatile memory 119c, the position calculation module 119e does not calculate the position of the user. Therefore, it is possible to prevent the guide Y from being displayed again for the user which has been already detected.

### Other Embodiments

While certain embodiments have been described, these embodiments have been presented by way of example only, and are not intended to limit the scope of the inventions. Indeed, the novel embodiment described herein may be embodiment in a variety of other forms; furthermore, substitutions and changes in the form of the embodiments described herein may be made without departing from the spirit of the inventions. The accompanying claims and their equivalents are intended to cover such forms or modifications as would fall within the scope and spirit of the inventions.

Though the three-dimensional image processor 100 has been described, for example, taking the digital television as an example in the above embodiment, the present invention is applicable to devices which present a three-dimensional image to a user (for example, a PC (Personal computer), a cellular phone, a tablet PC, a game machine and the like) and a signal processor which outputs an image signal to a display which presents a three-dimensional image (for example, an STB (Set Top Box)).

Further, the functions of the face detection module 119b, the same person judgment module 119d, and the position calculation module 119e included in the camera module 119 may be provided in the controller 114. In this case, the controller 114 will detect the face of a user from the image imaged by the imaging element 119a, judge whether the detected user is a person who has been already detected, and calculate the position of the user.

What is claimed is:

1. A three-dimensional image processing apparatus, comprising:
an imaging module configured to image a field comprising a front of a display, wherein the display is configured to display a three dimensional image; and
a controller configured to control the display to display an image imaged by the imaging module and a field comprising the three-dimensional image recognizable as a three-dimensional body.

2. The apparatus of claim 1, further comprising
a detection module configured to detect a user from the image imaged by the imaging module,
wherein the controller is configured to control the display to display fields comprising the three-dimensional image recognizable as a three-dimensional body, wherein the fields corresponds to the number of users detected by the detection module.

3. The apparatus of claim 2, further comprising
a position calculation module configured to calculate a position of the user detected by the detection module,
wherein the controller is configured to control the display to display the field closest from the position calculated by the position calculation module.

4. The apparatus of claim 1, further comprising
an operation accepting module configured to accept an instruction to display the field,
wherein, when the operation accepting module accepts the instruction, the controller is configured to control the display to display the image imaged by the imaging module and the field comprising the three-dimensional image recognizable as a three-dimensional body.

5. The apparatus of claim 2, further comprising
a judgment module configured to judge whether the user detected by the detection module is a user who has been already detected,
wherein, when the judgment module judges that the user detected by the detection module is a user who has been already detected, the controller is configured to control the display not to newly display the field.

6. The apparatus of claim 1,
wherein the controller is configured to control the display to display a frame indicating a boundary of the field.

7. A three-dimensional image processing apparatus, comprising
a controller configured to control a display configured to display a three-dimensional image to display an image imaged by an imaging module, wherein the imaging module is configured to image a field comprising a front of the display and a field comprising the three-dimensional image recognizable as a three-dimensional body.

8. The apparatus of claim 7,
wherein the controller is configured to control the display to display fields comprising the three-dimensional image recognizable as a three-dimensional body, wherein the fields corresponds to a number of users imaged by the imaging module.

9. A three-dimensional image processing method, comprising
controlling a display displaying a three-dimensional image to display an image of an imaged field comprising a front of the display, and a field comprising the three-dimensional image recognizable as a three-dimensional body.
